(19) United States
(12) Patent Application Publication
(10) Pub. No.: US 2007/0089678 A1
(43) Pub. Date: Apr. 26, 2007

(54) Pet feeding apparatus having adjustable elevation

(75) Inventor: Mark H. Greenwood, Arlington Heights, IL (US)

Correspondence Address: GREENBERG TRAURIG, LLP, 77 WEST WACKER DRIVE, SUITE 2500, CHICAGO, IL, 60601-1732, US

(73) Assignee: Petstages, Inc.

(21) Appl. No.: 11/255,273

(22) Filed: Oct. 21, 2005

(51) Int. Cl. A01K 5/01

(52) U.S. Cl. 119/61.5

(57) ABSTRACT

A pet feeding apparatus having a serving vessel, a base supporting the serving vessel above a surface, and an elevating member interposed between the serving vessel and the base. The elevating member is adjustable in height to, in turn, permit the serving vessel to be adjustable in height, relative to the surface. In one embodiment, the serving vessel includes a skirt member, which substantially conceals the elevating member when the elevating member is in a minimal height configuration. The serving vessel further includes a food containing portion having graduated regions, increasing progressively in size from a bottom surface to a top opening of a food containing portion, so as to provide an indicator of appropriate serving portions for puppies, grown dogs and senior dogs.

### BACKGROUND OF THE INVENTION

1. Field of the Invention

The present invention relates in general to pet feeding devices, and, more particularly, to a pet feeding device that is adjustable in elevation.

2. Background and the Prior Art

Feeding bowls are commonly employed to serve food, or water, to household pets, such as the family dog. Typically, a feeding bowl is filled with appropriate food for the dog and is then placed upon the floor. Traditional feeding bowls typically include a smooth, hemispherical food-containing region, which provides no ready indication, apart from the overall capacity of the bowl, of the amount of food that is being served therein.

While it may be relatively easy for puppies, or younger dogs, to eat from bowls placed directly upon a floor, some older and larger dogs may experience difficulties in eating food that is placed so low to the ground. Moreover, as a dog grows from young puppy to adult, the most comfortable, or appropriate height of the placement of food for feeding likewise increases.

Unlike traditional feeding bowls, the present invention is capable of continuing to comfortably serve food to a family pet, as it grows from an age following weaning and throughout its adulthood, by providing a bowl which is adjustable in height from the surface upon which it is placed for feeding.

Another object of the present invention is to provide a feeding bowl which includes a plurality of food portion measurement indicators, to facilitate serving an appropriate amount of food to a pet, such as a quantity recommended by the pet's veterinarian.

A further desirable characteristic of the present invention is that by providing an elevated feeding bowl, it is believed to be an aid to proper digestion for dogs.

These and other objects and features of the present invention will become apparent in view of the present specification, drawings, and claims.

### SUMMARY OF THE INVENTION

The present invention comprises a pet feeding apparatus, including a serving vessel having a food containing portion, a base supporting the serving vessel above a surface; and an elevating member interposed between the serving vessel and the base. The elevating member is adjustable in height to, in turn, permit the serving vessel to be adjustable in distance, relative to the base and, in turn, relative to the surface.

In one embodiment of the present invention, the serving vessel is releasably attachable to the elevating member, such as via an interference fit, a press fit, or a snap fit. In another embodiment of the present invention, the serving vessel is fixedly affixed to, or integrally formed with, the elevating member.

The elevating member is adjustable in height between a minimal height configuration and at least one expanded configuration. In one embodiment of the present invention, the elevating member is adjustable in height between a minimal height configuration and a maximal height configuration. Moreover, in one preferred embodiment, the elevating member is infinitely adjustable in height between the minimal and maximal height configurations.

In one embodiment of the present invention, the elevating member comprises a plurality of telescoping members, which may be threadedly interconnected. The elevating member may comprise four threadedly interconnected telescoping members, including a first elevating member operably attached to the base, a second telescoping member threadedly attached to the first telescoping member, a third telescoping member threadedly attached to the second telescoping member, and a fourth telescoping member threadedly attached to the third telescoping member and communicating with the serving vessel.

In another embodiment of the present invention, the elevating member comprises at least one bellows segment, movable between a collapsed configuration and an expanded configuration.

The serving vessel further includes a skirt member surrounding at least a portion of the food containing portion. In an embodiment of the present invention, the skirt member substantially conceals the elevating member when the elevating member is in a minimal height configuration. The skirt member includes at least one notch serving to form a handle region of the skirt member. The skirt member also includes a bottom surface constructed of a substantially non-skid material.

The food containing portion includes a plurality of graduated regions, which increase progressively in size from the bottom surface to the top opening of the food containing portion. At least one of the graduated regions is sized in accordance with a recommended meal portion size for a pet.

In an alternative embodiment of the invention, the elevating member further includes an indexing support framework positioned within the at least one bellows segment. In a preferred version of this alternative embodiment, the indexing support framework further comprises a bowl support, configured to contact and support the serving vessel. At least one first web is operably connected to the bowl support. At least one second web, operably connected to the at least one first web by an upper hinge element for free pivotability between the at least one first web and the at least one second web. At least one lower hinge arm is operably connected to the base. An indexing hinge structure is preferably disposed on a lower end of the at least one second web and an upper end of the at least one lower hinge arm, to enable the at least one lower hinge arm to be resistively pivotably indexable between at least two positions, to enable vertical adjustment of the elevating member and maintain the elevating member at a selected height.

### BRIEF DESCRIPTION OF THE DRAWINGS

FIG. 1 of the drawings is a top perspective view of the present feeding apparatus, showing, in particular, the serving vessel separated from the telescoping, elevatable base;

FIG. 2 of the drawings is a top plan view of the serving vessel;

FIG. 3 of the drawings is a side sectional elevation view of the serving vessel, taken along lines 3-3 of FIG. 2;

FIG. 4 of the drawings is an exploded side sectional elevation view of the elevatable base of FIG 1;

FIG. 5 of the drawings is a front top perspective view of another embodiment of the elevatable base, in its fully extended configuration;

FIG. 6 of the drawings is a front top perspective view of the elevatable base of FIG. 5, in its fully retracted configuration; and

FIG. 7 of the drawings is a front top perspective view of the elevatable base of FIGS. 5 and 6, in a partially extended configuration.

FIG. 8 is an exploded perspective view of an elevatable base and food bowl, of a further alternative embodiment of the present invention, in a partially extended configuration, and showing supporting structure which is situated on the interior of the elevatable base.

FIG. 9 is an enlarged, exploded view of a portion of the supporting structure of the embodiment of FIG. 8.

### DETAILED DESCRIPTION OF THE INVENTION

While this invention is susceptible of embodiment in many different forms, there are shown in the drawings and will be described in detail, several specific embodiments, with the understanding that the present disclosure is to be considered as an exemplification of the principles of the present invention and is not intended to limit the invention to the embodiments illustrated.

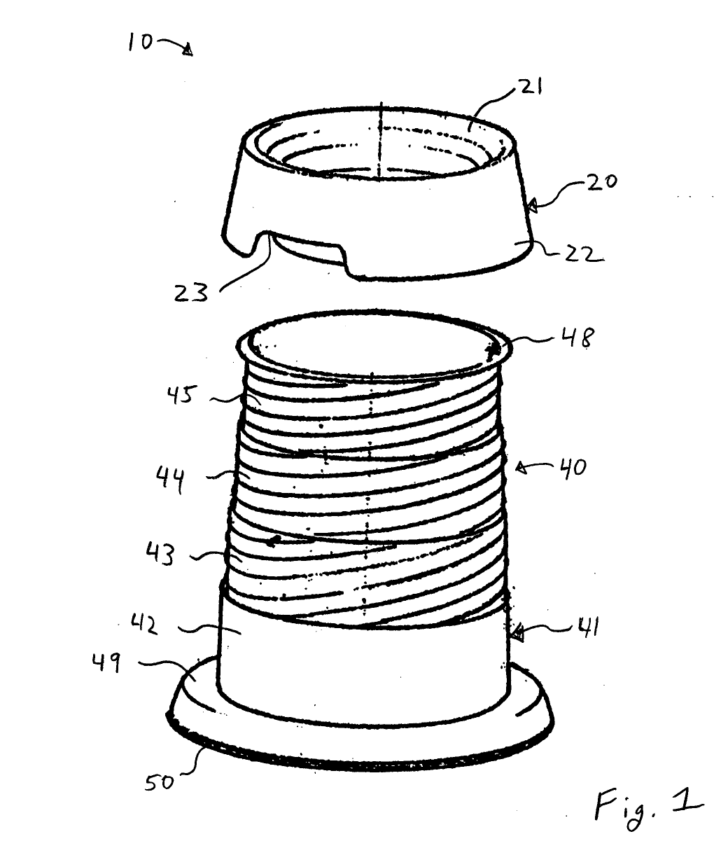

The present pet feeding apparatus is shown in FIGS. 1 through 4 as comprising serving vessel 20 and elevatable base 40. Serving vessel 20 includes food containing portion 21, skirt member 22, and two opposing notches 23, each serving to form an associated hand-hold, or gripping region, of skirt member 22.

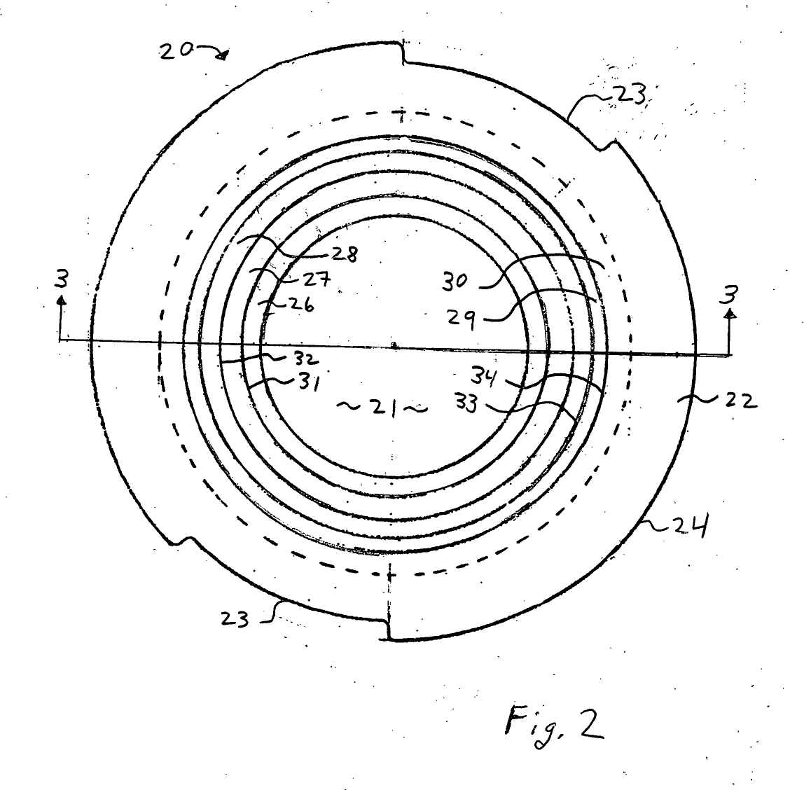

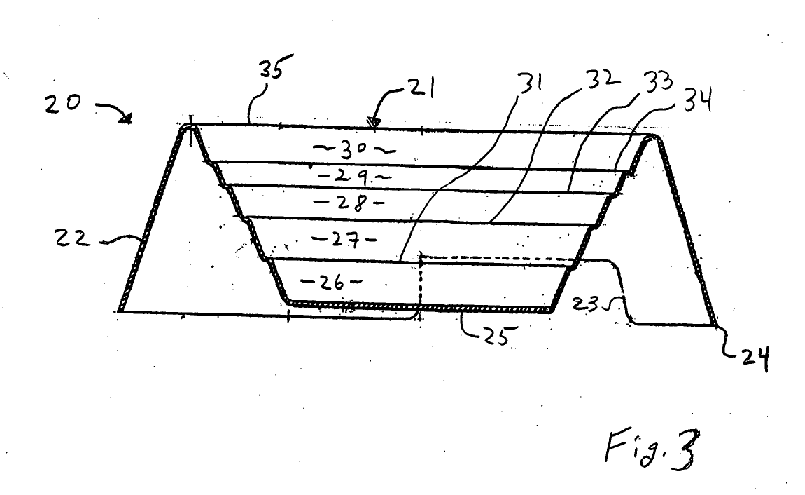

As shown in FIGS. 2 and 3, food containing portion 21 comprises a bottom surface 25, and five sequential frustoconical annular bands 26, 27 28, 29 and 30, disposed between bottom surface 25 and top aperture 35 of food containing portion 21. Each frustoconical annular band (apart from the bottommost band 26) is slightly larger in diameter than the annular band immediately beneath it. Accordingly, ledges 31, 32, 33 and 34 are disposed at the junctions of the respective annular bands, creating a “stepped” appearance of the interior surface of food containing portion 21.

Each ledge of food containing portion 21 forms a graduated, recommended serving portion of food that can be placed within food containing portion 21. For example, in one preferred embodiment, serving vessel 20 may comprise a feeding bowl with a maximum capacity of approximately 16 fluid ounces. In this embodiment, annular bands 26-29 are sized such that ledges 31, 32, 33, and 34 are indicative, when filled with pet food to each ledge, of serving portions of approximately 4 oz., 8 oz., 12 oz., and 16 oz., respectively. Accordingly, annular bands 26-29, together with ledges 31-34, provide a clear visual indication of a plurality of potential recommended serving quantities, such that food containing portion 21 may be filled with a specific, desired quantity of food, such as in accordance with a quantity recommendation by a pet's veterinarian. As a result, these graduation indicators accommodate the changing recommended food servings of pets, such as dogs, as they age and grow from puppy, to adult dog, to senior dog. The graduations also permit the food serving portions to be varied, depending upon whether the pet is considered to be overweight, underweight, or of normal weight. Moreover, whenever a pet's serving of food is left partially uneaten, these graduations provide a ready indication of the approximate uneaten portion and, in turn, permits the determination of approximately how much of the serving was actually consumed by the pet.

In another preferred embodiment, sized for larger pets, a feeding bowl with a maximum capacity of approximately 32 fluid ounces is provided. In this embodiment, annular bands 26-29 are sized such that ledges 31, 32, 33, and 34 are indicative, when filled with pet food to each ledge, of serving portions of approximately 8 oz., 16 oz., 24 oz., and 32 oz., respectively.

As best seen in FIG. 3, skirt member 22 extends from top aperture 35 to beyond bottom surface 25 of serving vessel 20. The bottom, circular edge of skirt member 22 accordingly supports the entirety of serving vessel 20 when the serving vessel is separated from elevatable base 40 and placed upon a flat surface, such as a floor. The bottom edge of skirt member 22 is preferably comprised of, or covered with, a substantially non-skid material 24. The non-skid material may be integrally formed with serving vessel 20, such as by overmolding. Alternatively, the non-skid material may comprise a separate, grooved ring, which is press fit to the bottom edge of skirt member 22. Moreover, serving vessel 20 may alternatively be formed entirely of a non-skid material. Two opposing notches 23, disposed within skirt member 22, permits air to flow in and out of the interior of skirt member 22, inhibiting the formation of a pressure seal between the bottom edge of skirt member 22 and a surface upon which serving vessel 20 is placed, which, if allowed to occur, could make it difficult to retrieve serving vessel 20 from the surface. Notches 23 further form associated hand-holds, or gripping regions within skirt member 22, making serving vessel 20 easier to carry, particularly when its weight is increased by a significant quantify of food or water contained therein.

Apart from non-skid material 24, serving vessel 20 is preferably constructed of a nonporous material, appropriate for regular contact with food, that is dishwasher safe. In a preferred embodiment, serving vessel 20 is constructed of a relatively rigid, plastic material, and is manufactured by injection molding. Alternatively, stainless steel or other metals may be employed.

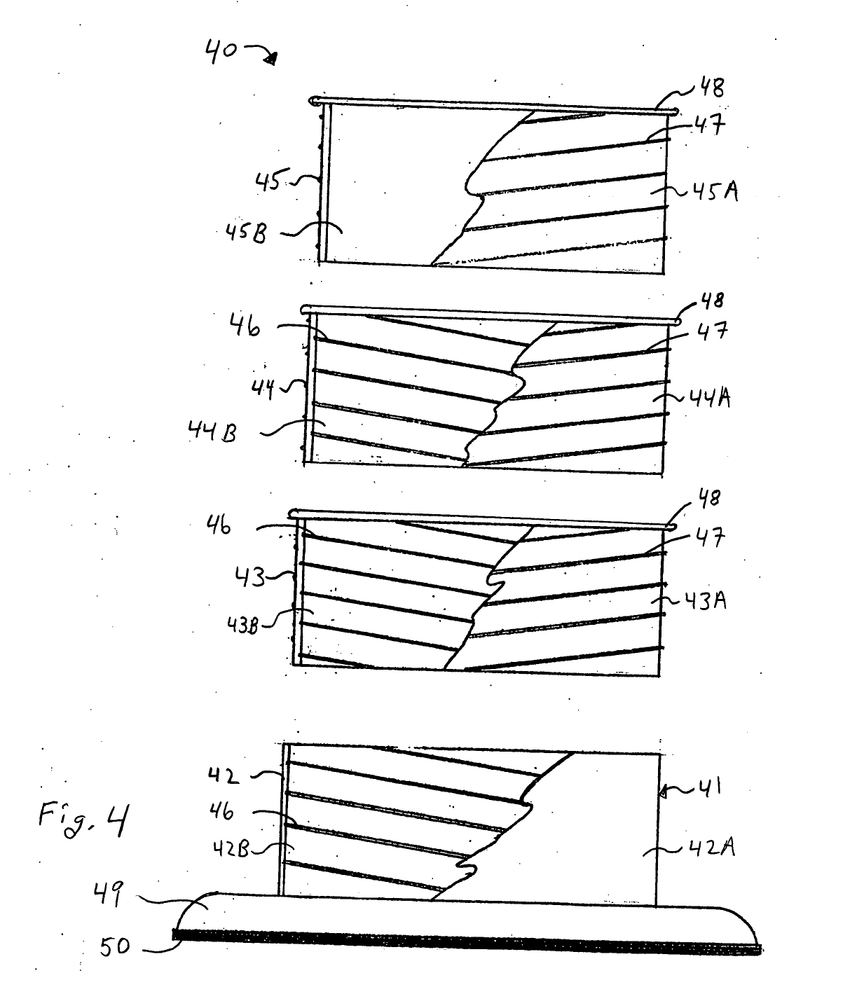

As shown in FIGS. 1 and 4, in one embodiment of the present invention, elevatable base 40 comprises pedestal, or base 41, and four telescoping, threadedly interconnected ring members 42, 43, 44 and 45. Ring members 42 through 45 collectively form an elevating member. Ring member 42 comprises an integrally formed portion of pedestal, or base 41, together with enlarged outer disc 49. Disc 49 is preferably sized to perform a sturdy base for elevatable base 40 and, in turn, serving vessel 20, when elevatable base 40 is placed upon a flat surface. For further stability, disc 49 may be internally weighted, or may be constructed of a relatively heavy material. For example, disc 49 may be formed using a blow molding process, and may include an aperture and associated cover, or plug, enabling disc 49 to be filled with sand or water, to add stabilizing weight to disc 49. A substantially non-skid ring 50 is preferably disposed about the outer circumference of disc 49. Alternatively, a non-skid material may be disposed about the entire bottom surface of disc 49.

As best seen in FIG. 4., ring members 42 through 45 are progressively smaller in diameter, so as to permit their sequential, threaded, telescoping interconnection. Ring member 42 includes a substantially smooth outer surface 42A, and male threads 46 disposed about inner surface 22B. Ring member 43 includes female threads 47 disposed about outer surface 43A, and male threads 46 disposed about inner surface 43B. Ring member 44 likewise includes female threads 47 disposed about outer surface 44A, and male threads 46 disposed about inner surface 44B. Ring member 45 includes female threads 47 disposed about outer surface 45A, and a substantially smooth inner surface 45B.

As shown in FIG. 4, ring member 45 includes collar 48, which serves as a support for serving vessel 20, as well as serving as a stop member, inhibiting ring member 45 from being threadedly retracted beyond the topmost edge of ring member 44. Ring member 44 likewise includes a collar 48, inhibiting ring member 44 from being threadedly retracted beyond the topmost edge of ring member 43. Moreover, ring member 43 also includes a collar 48, inhibiting ring member 43 from being threadedly retracted beyond the topmost edge of ring member 42. Additional stop members may employed within the internal surfaces of the ring members, to prohibit their threaded advancement to a point where the ring members may be physically separated from each other.

As shown in FIG. 1, serving vessel 20 is releasably attachable to elevatable base 40. The outer diameter of a portion of one of the frustoconical annular bands of serving vessel 20, such as band 28 (FIGS. 2-3), closely approximates the inner diameter of ring member 45, forming a relatively snug, or interference fit against collar 28 of ring member 45, as food containing portion 21 is pressed firmly downwardly into ring member 45. Through the application of sufficient force in the opposite direction, the interference fit is released, and serving vessel 20 may be separated from elevatable base 40, such as, for example, to facilitate washing serving vessel 20, or its replacement with another serving vessel upon elevatable base 40.

An alternative manner of mounting serving vessel 20 to elevatable base 40 is employed when serving vessel 20 is of a smaller diameter, such as a 16 oz. capacity bowl, wherein the diameter of frustoconical annular band 30 is smaller than the diameter of telescoping ring member 45. In this embodiment, it is the interior surface of skirt member 22, rather than one of the annular bands of serving vessel 20, which forms a snug, interference fit with collar 48 ring member 45. Moreover, an inwardly protruding ring may be disposed about the inner surface of skirt member 22. Alternatively, a series of protrusions, or lugs, may be disposed circumferentially about the inner surface of skirt member 22, such as at equidistantly spaced intervals. The internal ring, or lugs, may be employed to perform either a snap fit or an interference fit between skirt member 22 and collar 48 of ring member 45 to, in turn, releasably attach skirt member 22, and in turn, the entirety of serving vessel 20, to elevatable base 40.

Although, in a preferred embodiment, serving vessel 20 is releasably attachable to elevatable base 40, serving vessel 20 may, alternatively, be permanently attached to elevatable base 40, such as through the use of fasteners, adhesives, or sonic welding. Moreover, elevatable base 40 and serving vessel 20 may alternatively be integrally formed. Apart from non-skid material 50, elevatable base 40 is preferably constructed of a nonporous material, such as a relatively rigid, plastic material, and may be manufactured by separately injection molding each of the telescoping components. Alternatively, stainless steel or other metals may be employed

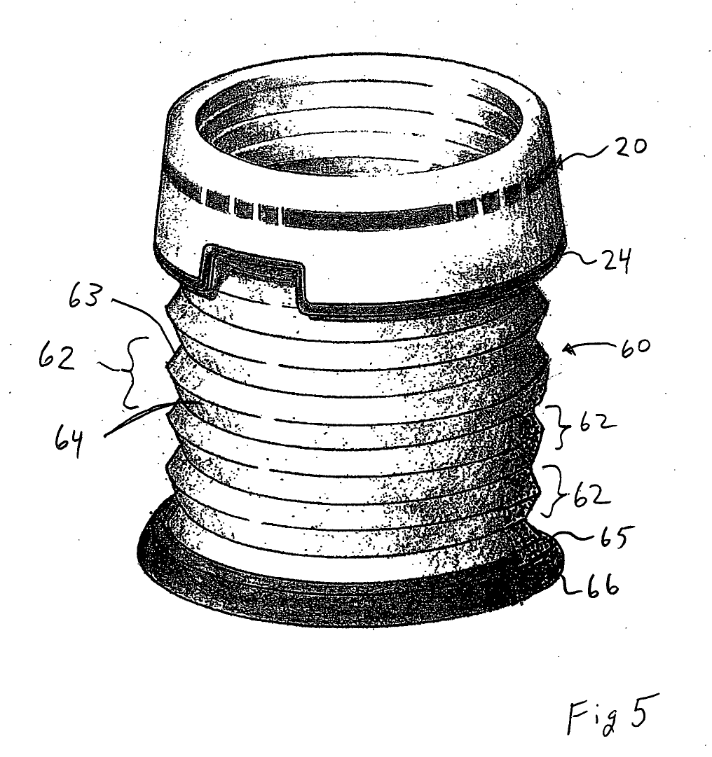

Another embodiment of the present invention is shown in FIGS. 5-7. In this embodiment, an alternative construction elevatable base 60 is shown as comprising enlarged outer disc 65, non-skid material 66, and a cylindrical side wall constructed of a plurality of collapsible bellows segments 62. Each collapsible bellows portion, in turn, comprises a pair of frustoconical elements, including upper bellows element 63 and lower bellows element 64. In particular, each upper element 63 comprises a downwardly, outwardly extending frustoconical band. Each lower segment 64 comprises an upwardly, outwardly extending frustoconical band. Each bellows segment is capable of individually controlled, manual collapsing and expanding, and of remaining in either the expanded and collapsed configuration, unless and until sufficient force is applied to reposition the bellows segment from the collapsed to the expanded configuration, or vice versa. The bellows segments accordingly collectively form an elevating member interposed between the serving vessel and a base formed by enlarged outer disc 65. A suitable, overall construction for the bellows segments of elevatable base 60 is disclosed, in the environment of a collapsible bottle, in U.S. Pat. No. 4,492,313. Elevatable base 60, and particularly bellows segments 62, are preferably constructed of a relatively rigid plastic material.

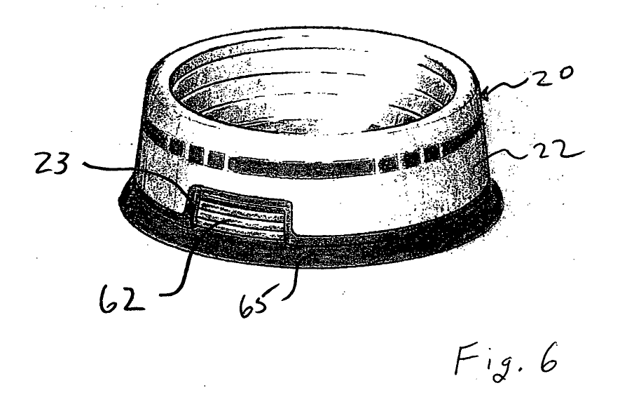

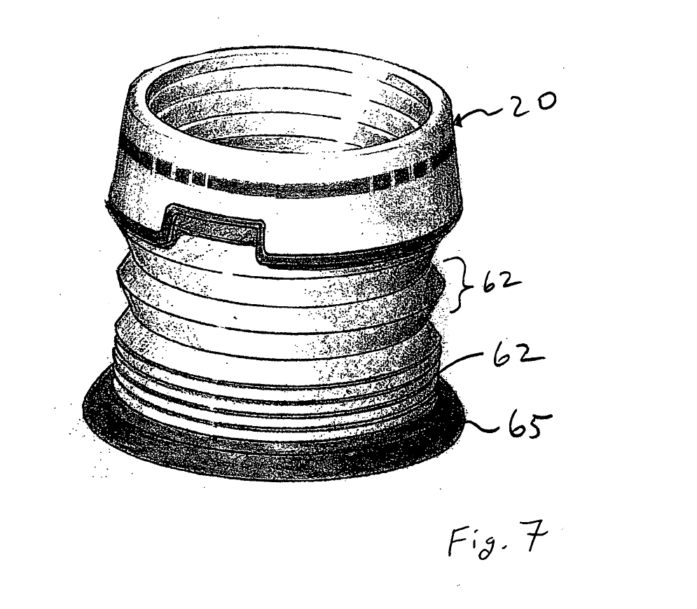

Bellows segments 62 permit the elevation of serving vessel 20 to be adjusted between a fully collapsed configuration (FIG. 6), wherein all of the bellows segments are fully collapsed, and a fully expanded configuration (FIG. 5), wherein all of the bellows segments are fully expanded. In the fully collapsed configuration of FIG. 5, skirt member 22 serves to substantially conceal all of the collapsed bellows segments, apart from those visible through opposing notches 23. As illustrated in FIG. 7, elevatable base 60 may be manually configured with some of the bellows in the collapsed configuration, and other bellows in the expanded configuration. By manually adjusting a desired quantity of the individual bellows segments between their collapsed and expanded configuration, the specific height of serving vessel 20 above the surface upon which elevatable base 60 rests may be selected from amongst a variety of potential elevations.

As described above with respect to threadedly telescoping elevatable base 40, serving vessel 20 may be releasably attachable to elevatable base 60, such as by a snug interference fit between a radial band of the serving vessel and a collar atop the elevatable base; or by means of a snap fit between lugs or a ring projecting inwardly from the interior surface of skirt member 22 and a collar of the elevatable base. Again, as discussed above with respect to telescoping elevatable base 40, serving vessel 20 may alternatively be permanently affixed to, or integrally formed with, bellows-like elevatable base 40.

Although, in the previously illustrated embodiments, the elevating member is disclosed as comprising either a plurality of threadedly interconnected telescoping portions, or a plurality of bellows segments, a variety of other forms of construction of the elevating member are likewise contemplated. For example, the elevating member may comprise a plurality of separate, stackable segments, each comprising a conical or cylindrical body proximate a bottom region, and a cylindrical collar, proximate a top region. By selecting the quantity of segments to stack between the base and the serving vessel, the height of the serving vessel above a surface may be adjusted from amongst a plurality of possible distances. Alternatively, the elevating member may comprise two or more telescoping elements which lock, in their extended configuration, through the use of cooperating fasteners, such as conventional pins and L-shaped slots, in a bayonet-type manner. Other fastening mechanisms, such as spring-loaded bearings cooperating with associated detents, and ratcheting mechanisms, for example, may also be employed to permit two or more members to be adjustable in a telescoping fashion, in order to provide the desired vertical adjustability of the elevating member.

While in the embodiment of FIGS. 5-7, the bellows segments portion of the elevatable base may be a fully self supporting unit, this may become problematic in larger-sized versions, as the articles' own weight, combined with the greater mass of food potentially retained in the serving vessel 20 may make it difficult to provide a fully self-supporting structure.

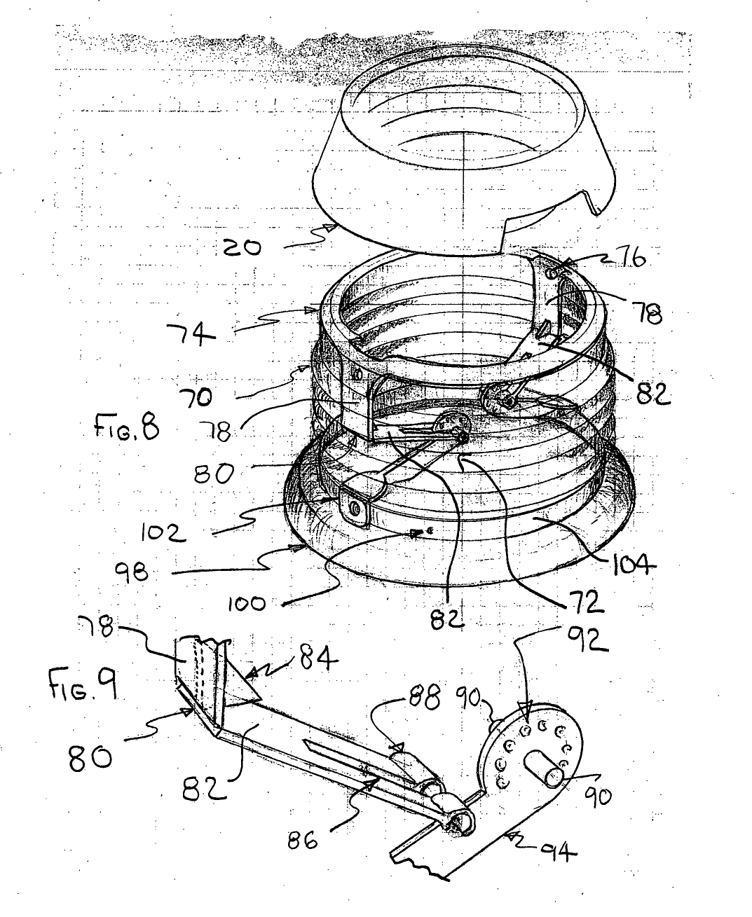

Accordingly, in a still further alternative embodiment of the invention, illustrated in FIGS. 8 and 9, the bellows segments 70 are essentially relieved of much of the support duty, by a dedicated support framework 72. Support framework 72, which is preferably fabricated completely from a plastic material (though other suitable materials, such as extruded or stamped metal, may be used) includes bowl support 74, which fits in the upper inside of the bowl 20, and is fastened to bellows segments portion 70 via apertures 76, using any suitable fastener, such as a screw, nut-and-bolt, or rivet. Descending from bowl support 74 are (preferably two) webs 78 which are connected via “living” hinges 80 to webs 82. Projecting from the inner surfaces of webs 78 are generally right-triangular vanes 84, which are provided to prevent webs 82 from being pivoted more than 90° relative to webs 78.

Webs 78 include slots 86, and lower hinge catches 88, situated on either side of slots 86. Hinge catches 88 are arcuate, and go through greater than 180° of arc, so as to snap-fit around pins 90, which project preferably from both sides of head 92 of lower hinge arm 94. A plurality of outwardly projecting “bumps” 96, preferably hemi-or semi-spherical in configuration, project from one or both sides of head 92. Slots 86 are preferably only slightly wider than the main portion of head 92, and therefore upon attempted rotation of webs 82, relative to lower hinge arms 94, bumps 96 butt up against the surfaces (upper or lower) of webs 82.

Being preferably made of plastic or a similar resilient material, sufficient application of force will cause the split lower ends of webs 82 to spread apart slightly and pass around whichever bumps are presently engaging the surfaces of the webs, in an indexing or ratcheting manner. Preferably, the force required to cause this indexing action will be substantially greater than the force which may ordinarily be exerted by the weight of food in the serving vessel 20, even if the dog puts a certain amount of weight (the amount an animal might ordinarily exert during feeding) downwardly upon the serving vessel, but not so much force as to be make adjustment of the base difficult for an ordinary individual.

Bellows portion 70 is preferably affixed to base portion 98 by any suitable method, such as by rivets 100. The lower ends of lower hinge arms 82 are likewise provided with tabs 102, through which suitable fasteners (not shown) are placed to affix lower hinge arms 82 to an upwardly projecting collar 104 on base portion 98.

The foregoing description and drawings merely explain and illustrate the invention, and the invention is not limited thereto, except insofar as the appended claims are so limited as those skilled in the art having the present disclosure before them will be able to make modifications and variations therein without departing from the scope of the invention.

What is claimed is:

1. A pet feeding apparatus comprising:
a serving vessel having a food containing portion;
a base supporting the serving vessel above a surface; and
an elevating member interposed between the serving vessel and the base, the elevating member being adjustable in height to, in turn, permit the serving vessel to be adjustable in distance, relative to the base and, in turn, relative to the surface.

2. The invention according to claim 1, wherein the serving vessel is releasably attachable to the elevating member.

3. The invention according to claim 2, wherein the serving vessel is attachable to the elevating member by an interference fit.

4. The invention according to claim 1, wherein the serving vessel and the elevating member are fixedly attached.

5. The invention according to claim 4, wherein the serving vessel and the elevating member are integrally formed.

6. The invention according to claim 1, wherein the elevating member is adjustable in height between a minimal height configuration and at least one expanded configuration.

7. The invention according to claim 6, wherein the elevating member is adjustable in height between a minimal height configuration and a maximal height configuration.

8. The invention according to claim 7, wherein the elevating member is infinitely adjustable in height between the minimal and maximal height configurations.

10. The invention according to claim 1, wherein the elevating member comprises a plurality of telescoping members.

11. The invention according to claim 10, wherein at least two of the telescoping members are threadedly interconnected.

12. The invention according to claim 11, wherein the elevating member comprises four threadedly interconnected telescoping members, including a first elevating member operably attached to the base, a second telescoping member threadedly attached to the first telescoping member, a third telescoping member threadedly attached to the second telescoping member, and a fourth telescoping member threadedly attached to the third telescoping member and communicating with the serving vessel.

13. The invention according to claim 1, wherein the elevating member comprises at least one bellows segment, movable between a collapsed configuration and an expanded configuration.

14. The invention according to claim 1, wherein the serving vessel further includes a skirt member surrounding at least a portion of the food containing portion.

15. The invention according to claim 14, wherein the skirt member substantially conceals the elevating member when the elevating member is in a minimal height configuration.

16. The invention according to claim 14, wherein the skirt member includes at least one notch serving to form a handle region of the skirt member.

17. The invention according to claim 14, wherein the skirt member includes a bottom surface constructed of a substantially non-skid material.

18. The invention according to claim 1, wherein the food containing portion includes a plurality of graduated regions.

19. The invention according to claim 18, wherein the graduated regions increase progressively in size from the bottom surface to the top opening of the food containing portion.

20. The invention according to claim 18, wherein at least one of the graduated regions is sized in accordance with a recommended meal portion size for a pet.

21. The invention according to claim 13, wherein the elevating member further includes an indexing support framework positioned within the at least one bellows segment.

22. The invention according to claim 21, wherein the indexing support framework further comprises:
a bowl support, configured to contact and support the serving vessel;
at least one first web, operably connected to the bowl support;
at least one second web, operably connected to the at least one first web by an upper hinge element for free pivotability between the at least one first web and the at least one second web;
at least one lower hinge arm, operably connected to the base; and
an indexing hinge structure, disposed on a lower end of the at least one second web and an upper end of the at least one lower hinge arm, to enable the at least one lower hinge arm to be resistively pivotably indexable between at least two positions, to enable vertical adjustment of the elevating member and maintain the elevating member at a selected height.
